(19) United States
(12) Patent Application Publication
(10) Pub. No.: US 2022/0194573 A1
(43) Pub. Date: Jun. 23, 2022

(54) Thrusters for Multi-Copter Yaw Control and Forward Flight

(71) Applicant: California Institute of Technology, Pasadena, CA (US)

(72) Inventor: Reza Nemovi, San Marcos, CA (US)

(73) Assignee: California Institute of Technology, Pasadena, CA (US)

(21) Appl. No.: 17/236,979

(22) Filed: Apr. 21, 2021

Related U.S. Application Data
(60) Provisional application No. 63/129,144, filed on Dec. 22, 2020.

(51) Int. Cl. B64C 27/68; B64C 27/37; B64C 27/32

(52) U.S. Cl. CPC B64C 27/68; B64C 29/0016; B64C 27/32; B64C 27/37

(57) ABSTRACT

A system and method for controlling a multi-rotor aircraft that implements a number of different lifting rotors that are configured to provide lift to the vehicle. Additionally, each of the lifting rotors have a corresponding yaw control rotor that can help provide yaw control as well as additional sideways movement control.

### CROSS-REFERENCED APPLICATIONS

This application claims priority to U.S. Provisional application 63/129,144 filed on Dec. 22, 2020. The disclosure of which are included herein by reference in their entirety.

### FIELD OF THE INVENTION

The present invention generally relates to multi-rotor aircraft. More specifically, it relates to the implementation of yaw control rotors in order to provide a stable and efficient control methodology.

### BACKGROUND

Most Vertical Takeoff and Landing (VTOL) vehicles are multi-copter vehicles having a number of different rotors. Typical VTOL systems have multiple fixed-pitch rotors that work to produce the forces necessary for flight; which include lift, thrust, and side movement, as well as roll, pitch, and yaw. Traditionally, for a multi-rotor copter VTOL the rotors are similar to an airplane propeller and is configured in the horizontal plane. This configuration generally provides the lift force necessary to lift the aircraft into the air for flight. The configuration of rotors or propellers can also be used to provide thrust forces at speeds that are generally below those needed for a fixed winged aircraft, where the wing can provide lift when moving at higher speeds. The forward thrust in a VTOL is typically managed by the control or change in rotational speed (RPM) of the various rotors. This can be done by varying the speed of one or more rotors to drive the direction of the vehicle by changing the thrust generated by the rotors.

The vast majority of drones and VTOL tend to be a quad copter design with four rotors. This is largely due to the inherent stability that a quad copter offers. The balanced configuration of rotors combined with counter rotation of adjacent rotors can make for a very stable design. Additionally, small changes to the speeds of the rotors can allow for relatively precise vehicle control. For example, reducing speed on all four rotors can allow for a smooth decent. Likewise, changes in speed of the aft two rotors can cause forward flight and the opposite is true for change in the forward two rotors. Similarly, the moment controls of roll, pitch, and yaw can be adjusted through changing speeds in the various rotors. Accordingly, flight control systems can be largely simplified making the quad copter an easy, go to design for VTOL. However, many such traditional designs can create issues in scalability, especially when trying to manage the various movements and moments of the aircraft.

### SUMMARY OF THE INVENTION

Many embodiments are directed to a multi-rotor vehicle that is further configured with auxiliary yaw control rotors that correspond to each of the individual flight rotors. For example, many embodiments are directed a multi-rotor vehicle that has a body configured with a plurality of lifting rotors, each of the lifting rotors are connected to the body and provide lift to the vehicle. In many embodiments, each of the lifting rotors has a corresponding yaw control rotor connected to the body and disposed on a plane lower than and perpendicular to that of each of the lifting rotors.

Many embodiments are directed to a multi-rotor vehicle with a fuselage configured to support a lifting rotor system, wherein the lifting rotor system has a plurality of lifting rotors connected to the fuselage and configured to generate lift sufficient to provide flight capabilities in the vehicle. The vehicle also has a plurality of yaw control rotors connected to the fuselage and disposed at a location adjacent to each of the plurality of lifting rotors, wherein each of the plurality of yaw control rotors can work independently or in cooperation with other yaw control rotors to control the yaw moment of the vehicle.

In other embodiments, each of the plurality of lifting rotors are selected from a group consisting of fixed pitch, variable pitch, and swashless variable pitch rotors.

In still other embodiments, each of the plurality of yaw control rotors corresponds to a respective lifting rotor.

In yet other embodiments, each of the yaw control rotors are moveably connected to the fuselage and are configured to provide a horizontal side force in addition to yaw control.

In still yet other embodiments, the fuselage provides a housing around each of the plurality of yaw control rotors.

In other embodiments, each of the plurality of yaw control rotors is selected from a group consisting of fixed pitch, variable pitch, and swashless variable pitch rotors.

In still other embodiments, the vehicle has a vehicle control system electronically connected to each of the plurality of lifting rotors and each of the plurality of yaw control rotors, wherein the vehicle control system transmits signal to each of the plurality of lifting and yaw control rotors to generate a controlled flight.

In yet other embodiments, the plurality of lifting rotors is at least three rotors.

In still yet other embodiments, he plurality of yaw control rotors is disposed in a plane beneath and perpendicular to each of the plurality of lifting rotors.

In other embodiments, wherein the fuselage comprises a body portion having a plurality of leg elements extending outward from the body portion, wherein each of the plurality of lifting rotors and yaw control rotors are disposed on at least one of the plurality of leg elements.

In still other embodiments, the vehicle has a vehicle control system, wherein the vehicle control system is disposed within the body portion and is electronically connected to each of the plurality of lifting rotors and yaw control rotors.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a traditional quad copter configuration consistent with known art.

FIG. 2 illustrates a tri-copter configuration with corresponding yaw control rotors in accordance with embodiments of the invention.

FIG. 3 illustrates a main rotor and corresponding yaw control rotor in accordance with embodiments of the invention.

FIG. 4 illustrates a control system configuration in accordance with embodiments of the invention.

### DETAILED DESCRIPTION

Turning now to the drawings, systems and methods for improving flight control are illustrated. Many embodiments are directed to a vehicle designed with a plurality of rotors that are considered to be lifting rotors. In other words, the lifting rotors are configured to provide lift to the vehicle. The number of rotors can vary and can be even or odd depending on the desired configuration and shape of the body of the vehicle. Corresponding to each of the lifting rotors, many embodiments, include a yaw control rotor. The rotation and subsequent thrust of the corresponding yaw control rotors can help generate necessary yaw moments during flight of the vehicle. This can be useful in a number of situations and can subsequently reduce the need for the lifting rotors to provide yaw control support. The yaw control rotors can be positioned lower than the main lifting rotors and may even be positioned below the main body. This can be done in any number of ways known in the art. Additionally, the yaw control rotors may be at any location along a linear path with respect to the corresponding lifting rotor.

As can be appreciated, the main moments of an aircraft called roll, pitch, and yaw are the rotational movements of the aircraft about each of the x, y, and z axis in a cartesian coordinate system. Such movements can have dramatic effects on the overall position of the aircraft, especially when in motion. Therefore, providing adequate control of the aircraft moments is essential to efficient and proper flight control. Additionally, the control of the rotor's themselves can have an affect on the various moments and subsequent overall vehicle movement. For example, some vehicles employ fixed-pitch rotors while others may use variable pitched rotors. Adjusting the pitch of the rotor can offer a number of advantages and complexities in flight control.

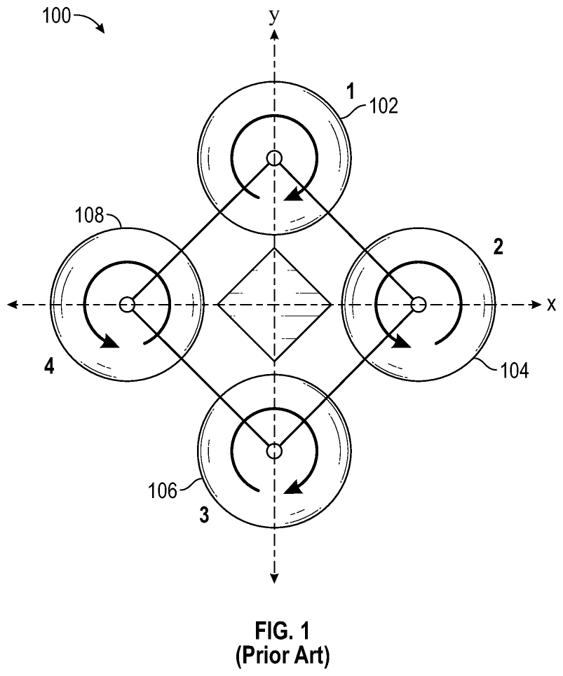

Conventional VTOL and copter type drones tend to use a fixed-pitch approach to rotors. The fixed-pitch approach requires that the rotors be of equal size. As previously mentioned, the conventional flight control is managed through the acceleration/deceleration of one or more of the rotors. For example, FIG. 1 illustrates a conventional layout of a quadcopter 100 with individual rotors 102-108. As can be seen, each of the adjacent rotors are configured to rotate in opposing directions to help balance the torque generated by the rotor. Because all of the rotors are of equal size control methodologies can create various problems. For example, the desired change in moments (roll, pitch, yaw) entails a change in forces (lift, thrust, side force) which can require non-linear relationships that require control software to implicitly decouple the moments from the forces to allow for accurate control of the vehicle. Additionally, more conventional designs inherently account for the torque generated by the rotors by providing an equal and opposite rotor to counter the torque generated. This generally can create problems for vehicles that may have an odd number of rotors.

In order to counter act the effects torque and unbalanced torque, some conventional systems also utilize alternative anti-torque mechanisms such as a tail rotor that can act to counteract the torque as well as provide yaw control. Other systems can utilize a complex software that blends commands to other rotors. Consequently, this results in a complex highly coupled flight control system. By coupled, we are referring to the coupling between rotors and the control of the rotors to generate the movement and moment forces. Furthermore, due to the complexity and coupling of the movements, the control bandwidth is limited by the rate of acceleration/deceleration of the subject rotors. As the vehicle size increases, the control bandwidth become untenably small. Accordingly, scalability can be limited with more traditional designs creating more complexity in control and design configuration.

In contrast, many embodiments allow for improved scalability and flight control through an unconventional approach to vehicle design. For example, many embodiments include a number of lifting rotors where each of the lifting rotors have a corresponding yaw control rotor. Although various embodiments refer to the corresponding rotor as a “yaw control rotor” it should be understood that yaw control is only one of a number of functions the corresponding rotor is capable of.

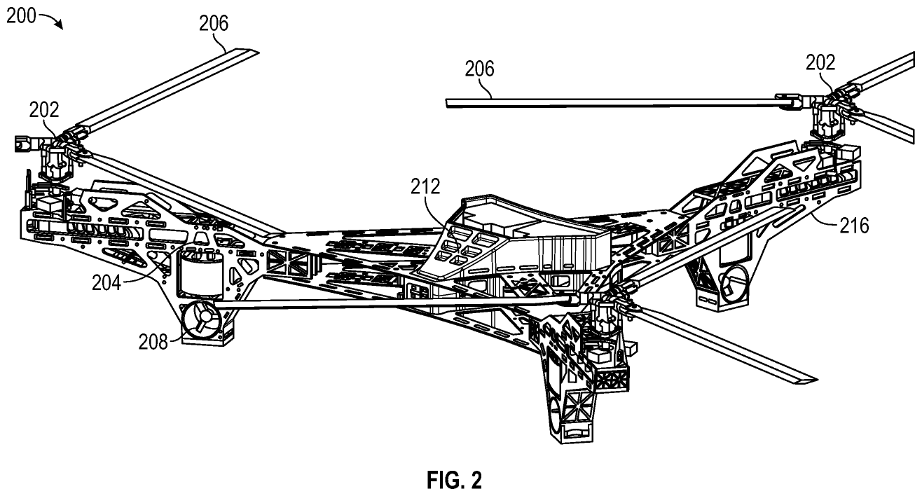

Referring not to FIG. 2, an embodiment of a multi-rotor vehicle is shown. The vehicle 200 can have a number of different rotor configurations. Accordingly, some embodiments may have three lifting rotors 202 that are connected to an upper portion of the fuselage 204. The lifting rotors 202 as can be appreciated are designed to generate lift for the vehicle and can be configured in a number of different ways. For example, some rotors may have a fixed pitch configuration similar to a more conventional design. Other embodiments may utilize variable pitch rotors that allow for the lifting rotors to provide additional forces on the vehicle that can aid in controlling pitch, roll, and yaw. Additionally, some lifting rotors 202 can be swashless, or configured to adjust the pitch without the use of a swashplate. A swashplate is a mechanically connection between the motor of the rotor and the various blades 206 of the rotor 202. The swashplate can allow for the adjustment of the pitch of the blades in accordance with the input from the pilot or control system. Accordingly, the removal of such mechanical devices can simplify the functions of the overall system and improve efficiency of the controls.

As can be appreciated, the various movements and moments of the vehicle can be affected by the movement and change in movement of the number of rotors. As seen in FIG. 2, many embodiments can have a number of different yaw control rotors 208 that are positioned in a plane that is perpendicular to that of the lifting rotors 202. This can allow for each of the yaw control rotors 208 to provide a force that is perpendicular to the lift. Accordingly, the yaw control rotors 208 can help to counter act any unbalanced torque that may be generated from the position of the lifting rotors. This is especially true when you have an odd number of rotors such as the embodiment illustrated in FIG. 2. The yaw control rotors 208 can be positioned in a number of different locations, however, numerous embodiments can have the yaw control rotors 208 placed such that they correspond with each of the lifting rotors 202.

It can be appreciated that many embodiments of a multi-rotor vehicle can have a number of different configurations. For example, a fuselage 204 can be used to support and/or house the various rotors (lifting and yaw) of the vehicle 200. In some embodiments, the fuselage can have a main body 212 that is centrally located. The main body 212 can be used to house a number of different components such as control mechanisms and computers. Other items such as sensors or power sources can also be housed within the body 212. As can be appreciated, the various components can be placed at any number of locations on the vehicle that help to serve the overall purpose of the vehicle. For example, some embodiments may have legs 216 that extend outward from the main body 212 and are used to support the lifting rotors 202 as well as the yaw control rotors 208. Although the yaw control rotors 208 are shown aligned with a corresponding lifting rotor 202, it can be appreciated that the yaw control rotor 208 can be offset or out of plane with the lifting rotor and still be a corresponding rotor to the lifting rotor.

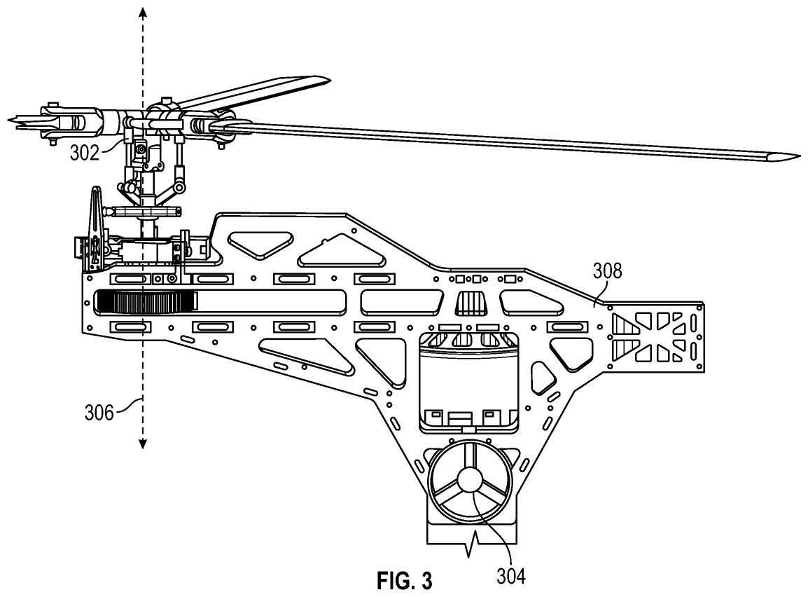

FIG. 3 illustrates an embodiment of combination of lifting rotors 302 and a corresponding yaw control rotor 304. It can be seen that the yaw control rotor 304 is positioned lower than the lifting rotor 302. In some embodiments, the yaw control rotor 304 can be offset from the central axis 306 of the lifting rotor 302. Some embodiments may position the yaw control rotor directly beneath the lifting rotors 302. As can be appreciated, the yaw control rotors 304 can be positioned at any desired location such that the output force from each of the yaw control rotors is enough to help control the flight of the vehicle. Additionally, in some embodiments, the yaw control rotors can be rotatably connected to the fuselage 308. This can serve to allow the yaw control rotors to function not only to control yaw, but also to help augment the forward, rearward, and sideward thrust of the vehicle during flight.

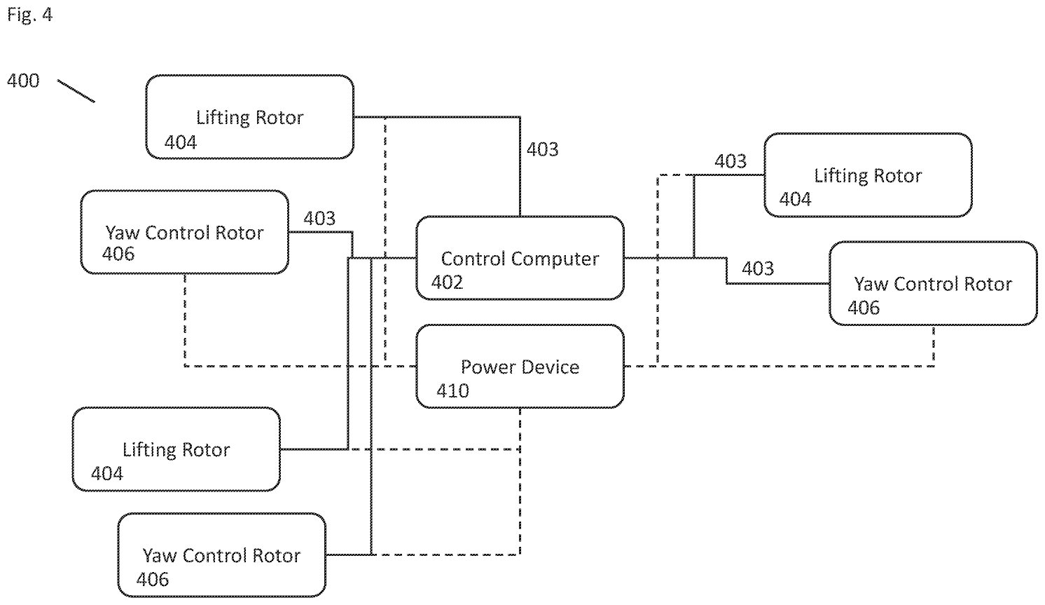

As has been discussed previously, many embodiments can have a number of different interconnections between the different control systems. For example, FIG. 4 illustrates a schematic of a control system 400 that might be used in a number of embodiments of a multi-rotor vehicle. In many embodiments, a control system 400 can have a control computer 402 that is configured to generate and transmit control signals 403 to each of the lifting rotors 404 as well as the corresponding yaw control rotors 406. As can be appreciated, each of the lifting rotors 404 and yaw control rotors can be independently controlled from the control computer. Additionally, a number of embodiments will require a power system 410 that is connected to the control computer and the various rotors of the vehicle. The power system can be any system that is capable of providing the necessary power to run the vehicle, such as a battery. Additionally, various embodiments can be equipped with a number of sensors 412 that are in communication with the control computer 402 and used for autonomous flight or improved flight capabilities.

### Summary & Doctrine of Equivalents

As can be inferred from the above discussion, the above-mentioned concepts can be implemented in a variety of arrangements in accordance with embodiments of the invention. Specifically, a multi-rotor vehicle with a number of lifting rotors and corresponding yaw control rotors. Additionally, a number of embodiments incorporate additional smaller thrust rotors to generate thrust and/or yaw control of a vehicle.

Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A multi-rotor vehicle comprising:
a fuselage configured to support a lifting rotor system, wherein the lifting rotor system comprises
a plurality of lifting rotors connected to the fuselage and configured to generate lift sufficient to provide flight capabilities in the vehicle;
a plurality of yaw control rotors connected to the fuselage and disposed at a location adjacent to each of the plurality of lifting rotors, wherein each of the plurality of yaw control rotors can work independently or in cooperation with other yaw control rotors to control the yaw moment of the vehicle.

2. The multi-rotor vehicle of claim 1, wherein each of the plurality of lifting rotors are selected from a group consisting of fixed pitch, variable pitch, and swashless variable pitch rotors.

3. The multi-rotor vehicle of claim 1, wherein each of the plurality of yaw control rotors corresponds to a respective lifting rotor.

4. The multi-rotor vehicle of claim 1, wherein each of the yaw control rotors are moveably connected to the fuselage and are configured to provide a horizontal side force in addition to yaw control.

6. The multi-rotor vehicle of claim 1, wherein the fuselage provides a housing around each of the plurality of yaw control rotors.

7. The multi-rotor vehicle of claim 1, wherein each of the plurality of yaw control rotors is selected from a group consisting of fixed pitch, variable pitch, and swashless variable pitch rotors.

8. The multi-rotor vehicle of claim 1, further comprising a vehicle control system electronically connected to each of the plurality of lifting rotors and each of the plurality of yaw control rotors, wherein the vehicle control system transmits signal to each of the plurality of lifting and yaw control rotors to generate a controlled flight.

9. The multi-rotor vehicle of claim 1, wherein the plurality of lifting rotors is at least three rotors.

10. The multi-rotor vehicle of claim 1, wherein the plurality of yaw control rotors is disposed in a plane beneath and perpendicular to each of the plurality of lifting rotors.

11. The multi-rotor vehicle of claim 1, wherein the fuselage comprises a body portion having a plurality of leg elements extending outward from the body portion, wherein each of the plurality of lifting rotors and yaw control rotors are disposed on at least one of the plurality of leg elements.

12. The multi-rotor vehicle of claim 11, further comprising a vehicle control system, wherein the vehicle control system is disposed within the body portion and is electronically connected to each of the plurality of lifting rotors and yaw control rotors.
